(19) United States
(12) Patent Application Publication
(10) Pub. No.: US 2005/0286568 A1
(43) Pub. Date: Dec. 29, 2005

(54) Method and apparatus to display network information of an inverse multiplexed asynchronous transfer mode network

(76) Inventors: Canning Hsueh, Colorado Springs, CO (US); Allan Wallace Dodge, Colorado Springs, CO (US); Robert Geoffrey Ward, Colorado Springs, CO (US); Alan Paul Huff, Colorado Springs, CO (US); David Marlor, Colorado Springs, CO (US); Bernhard Gaider, Colorado Springs, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/878,234

(22) Filed: Jun. 29, 2004

(51) Int. Cl. H04J 3/04

(52) U.S. Cl. 370/536

(57) ABSTRACT

A method and apparatus of displaying traffic information of an inverse multiplexed asynchronous transfer mode network. The traffic information of an inverse multiplexed asynchronous transfer mode network is autodetected and summarized in real time, and the summarized traffic information is displayed in a tabular form. The traffic information includes corresponding inverse multiplexed link status information, corresponding inverse multiplexed group information of the inverse multiplexed links, link information of each of the inverse multiplexed links, and group delay information of the inverse multiplexed links. Further, the traffic information indicates correctness of connection configuration using a graphical user interface. Accordingly, a selectable graphical user interface is provided for presenting users with traffic information of an inverse multiplexed asynchronous transfer mode network in a user-friendly manner.

### BACKGROUND OF THE INVENTION

1. Field of the Invention

The present invention relates to providing network information. More particularly, the present invention relates to analyzing and displaying network information of an inverse multiplexed asynchronous transfer mode network via a user interface.

2. Description of the Related Art

Generally, transfer of digital information over long distances is accomplished via packet/cell switching communication networks. An asynchronous transfer mode (ATM) network is one type of packet/cell switching communication network that is commonly used. An ATM network allows digital information including voice, video and data to be transferred via common carrier communication links.

Inverse multiplexing over asynchronous transfer mode (IMA) allows high-speed streams of ATM cells to be broken up and typically be transmitted across multiple T1/E1 communication links. The cells are then reconstructed into the original ATM cell order upon arrival at a destination. A typical IMA network includes several ATM network connections (logical connections) inverse multiplexed into numerous links that are grouped together into IMA groups where each IMA group corresponds to one logical connection. IMA networks are well known.

Accordingly, it is important to provide a user with a network diagnostic tool that allows the user to determine what is happening on the ATM network by deciphering the network information and displaying the network information. This becomes especially important when the user needs to analyze status of the ATM network to diagnose network related problems. Unfortunately, with typical network monitoring and diagnostic tools, the user is provided with network information that does not allow the user to easily discern network traffic information and easily pinpoint network related problems. Further, typical network monitoring and diagnostic tools simply display error messages when an error occurs and do not assist the user in determining characteristics of the error.

### SUMMARY OF THE INVENTION

The present invention provides a method of autodetecting and summarizing traffic information of an inverse multiplexed links of an ATM network, and displaying the summarized traffic information in a tabular form. According to an aspect of the present invention, the traffic information includes corresponding inverse multiplexed group information of the inverse multiplexed links of the IMA network. The traffic information also includes link information of each of the inverse multiplexed links of the IMA network, and group delay information of the inverse multiplexed links. Further, the present invention provides a method for displaying traffic information indicating correctness of connection configuration using a graphical user interface having color-coded buttons and text tips indicating the correctness of connection configuration.

The present invention also provides a method of displaying summarized status information of an inverse multiplexed links of ATM networks using a selectable graphical user interface. According to an aspect of the present invention, the selectable graphical user interface is configured to display selected status information of the inverse multiplexed links. Further, the summarized status information includes at least one of inverse multiplexed link status information, inverse multiplexed group identification information, inverse multiplexed link identification information, inverse multiplexed link delay information, and inverse multiplexed group select status information.

Moreover, the present invention provides a network analyzing apparatus with a graphical user interface summarizing traffic data of an ATM network with grouped inverse multiplexed links connected with corresponding ports. According to an aspect of the present invention, the summarized traffic data of the ATM network includes data of grouped inverse multiplexed links connected with corresponding ports, which indicates when an error occurs in relation to the grouped inverse multiplexed links. Further, according to an aspect of the present invention, the summarized traffic data of the ATM networks indicating the error in relation to the grouped inverse multiplexed links provides text to explain characteristics of the error.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an inverse multiplexed asynchronous transfer mode network, according to an embodiment of the present invention.

FIG. 2 is a diagram illustrating a process for autodetecting, summarizing and displaying traffic information of an inverse multiplexed asynchronous transfer mode network, according to an embodiment of the present invention.

FIG. 3 is a diagram illustrating a graphical user interface for displaying traffic information of the inverse multiplexed asynchronous transfer mode network shown in FIG. 1, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

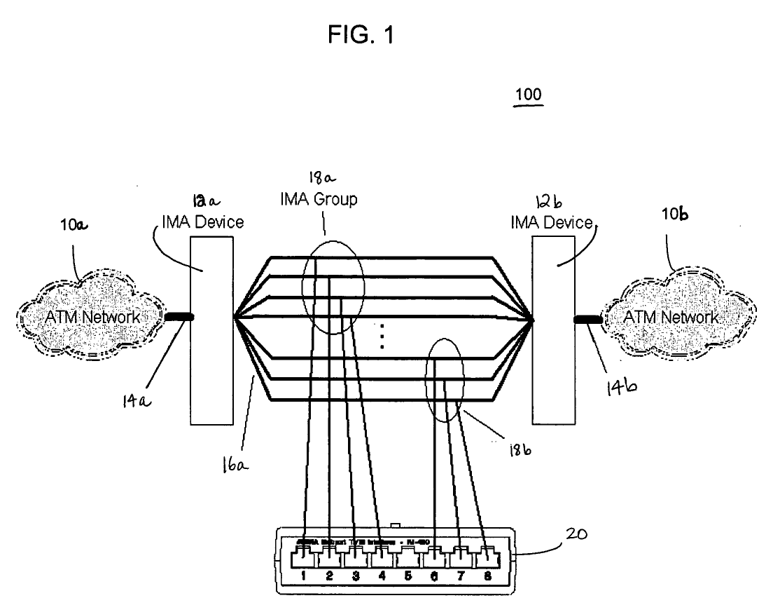

FIG. 1 is a diagram illustrating an inverse multiplexed ATM network 100. Referring to FIG. 1, ATM networks 10a and 10b are coupled for communication over multiple IMA connections 16a, such as T1 or E1 lines, inverse multiplexed into numerous links. While the IMA connections 16a are described in terms of T1 or E1 lines, the present invention is not limited to T1 or E1 lines. The ATM networks 10a and 10b exchange streams of ATM cells using the IMA connections 16a. The streams of ATM cells are transmitted from the ATM networks 10a and 10b via high-speed ATM connections 14a and 14b, such as OC-3, DS3/E3, etc., respectively. However, the present invention is not limited to the OC-3, DS3/E3 connections. Accordingly, an ATM cell is broken up and reconstructed via the IMA device 12a and IMA device 12b to be exchanged across the inverse multiplexed links. For example, an original ATM cell transmitted from ATM network 10a is separated into two or more ATM cells via the IMA device 12a and the two or more ATM cells are reconstructed into the original ATM cell via IMA device 12b for transmission to ATM network 10b. The use of IMA devices, IMA connections, and IMA groups is well known.

Each of the IMA connections 16a has line channel and equipment channel links. Further, as shown in FIG. 1, communication links are grouped together into IMA group 18a and IMA group 18b, where each IMA group corresponds to one logical connection. The IMA group 18a and IMA group 18b are connected with eight-port T1/E1 line interface module (LIM) 20. While the above example describes the IMA groups connected with eight-port, the present invention is not limited to any particular number of ports.

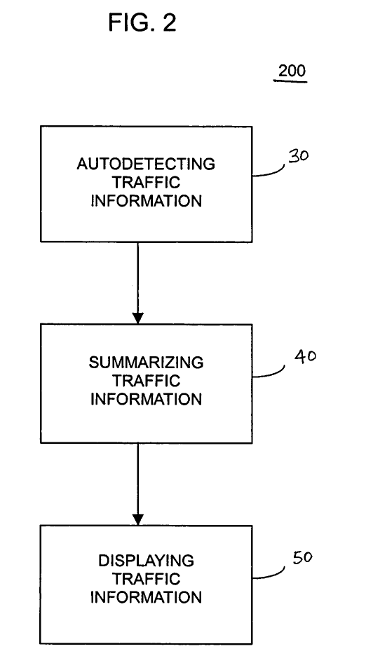

FIG. 2 is a diagram illustrating a process 200 for autodetecting, summarizing, and displaying traffic information of inverse multiplexed links of asynchronous transfer mode networks, according to an embodiment of the present invention. Referring to FIG. 2, in operation 30, traffic information of IMA network is detected. According to an aspect of the present invention, the autodetection of the traffic information is accomplished non-intrusively, and various methods of network traffic detection are used to detect the IMA traffic information. It is well known how to autodetect traffic information.

From operation 30, the process 200 moves to operation 40, where the autodetected traffic information is summarized. Here, the traffic information can be summarized using various methods, and the present invention is not limited to any specific methods of summarizing the autodetected traffic information. It is well known how to summarize traffic information.

From operation 40, the process 200 moves to operation 50, where the summarized traffic information of the ATM network is displayed. Accordingly, the displayed traffic information the ATM network provides clear visual ATM network information including corresponding inverse multiplexed link status information, corresponding inverse multiplexed group information of the inverse multiplexed links of the IMA network, link information of each of the inverse multiplexed links of the IMA network, and group delay information of the inverse multiplexed links. Further, the displaying the traffic information provides information indicating correctness of connection configuration using a graphical user interface where the graphical user interface includes color-coded buttons and text tips indicating the correctness of connection configuration.

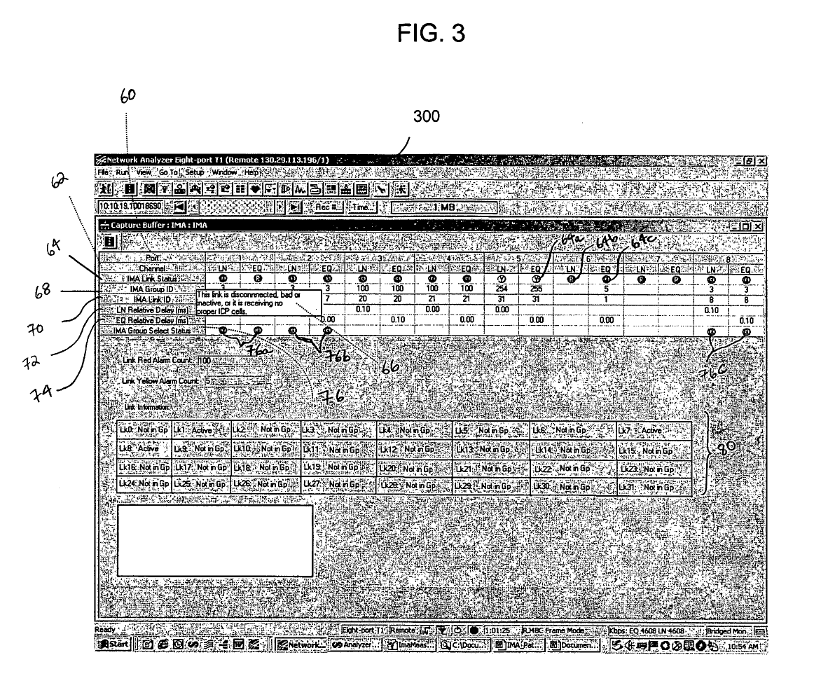

FIG. 3 is a diagram illustrating a graphical user interface 300 for displaying traffic information of the IMA network. As shown in FIG. 3, the graphical user interface 300 collects statistics information of the IMA network and presents the information in a tabular format in a user-friendly manner. Here, the graphical user interface 300 displays port information 60 of the IMA groups including ports 1 through 8. However, as noted previously, the present invention is not limited to any particular number of ports.

As indicated in FIG. 3, channel information 62 including line (LN) and equipment (EQ) channels carried on each physical T1/E1 line are displayed in the graphical user interface 300. The channel information 62 is detected at each LIM port, and a pair of LN and EQ channels carried on each physical T1/E1 line corresponds to an IMA link.

Further, in FIG. 3, IMA link status 64 includes information related to the status of each IMA link and the status of each LIM port. According to an aspect of the present invention, the links in different ports are treated separately, thus there is no inter-port correlation. The IMA link status 64 is indicated using color-coded buttons. For example, a green button is used to indicate that all available data analyzed indicates that the link is active and healthy, that there is no line status errors/warnings in a link, and good and properly spaced cells are being received. A red button is used to indicate that there are line status errors and/or warnings, no good cells have been received, or the cells are not spaced properly. And a yellow button may be used to indicate a warning indicating potential errors. According to an aspect of the present invention, it is also possible to obtain more detailed information in relation to the line status of the link. To obtain more detailed information in relation to the IMA link status, a mouse pointer may be placed over the top of any one of the IMA link status indicators 64a, 64b, or 64c, and a more detailed explanation of the status 66 is displayed.

As shown in FIG. 3, the graphical user interface 300 also displays IMA group identification (ID) information 68. Accordingly, all detected group IDs are shown in corresponding columns and corresponding columns are left blank when group IDs cannot be detected. For example, as shown in FIG. 3, the IMA group ID information 68 displayed corresponding to ports 1, 2 and 8 is the number 3, and the IMA group ID information 68 displayed corresponding to port 7 is left blank. Similarly, the graphical user interface 300 displays IMA link ID information 70 displaying all detected IMA link IDs. For example, the IMA link ID information 70 corresponding to port 3 is the number 20, and the IMA link ID information 70 corresponding to port 7 is left blank.

Further, when IMA link status 64 displays indicator 64c, LN relative delay 72 and EQ relative delay 74 are displayed to indicate detected relative delays (in millisecond resolution) of IMA links in a group in the line or equipment channel. According to an aspect of the present invention, delays are calculated on a per-channel basis. For example, for each link, an arrival time of cells in a fixed position within an IMA frame are recorded, and the link with the smallest arrival time is used as a reference point and assigned a zero delay value. This allows delays of other links with larger arrival time to be measured relative to arrival time of the reference link. However, in cases where there is more than one link with minimum delays, multiple links will show zero delay values.

As shown in FIG. 3, the graphical user interface 300 further displays IMA group select status 76 indicating whether corresponding links of IMA groups whose data is to be captured and analyzed are connected, and whether ports connected to the respective links in the IMA group are selected. For example, IMA group select status 76 displayed with respect to ports 1, 2 and 8 has indicators 76a, 76b and 76c, respectively, to indicate that all the active links in the selected group (group 3) are connected with corresponding ports, to indicate that all the ports corresponding to the active links in the IMA group are selected, etc. The IMA group select status 76 further indicates when more than one group of IMA traffic is selected, when there is no valuable IMA traffic information in the channels, and when there are duplicate links in a selected IMA group. Further, the IMA group select status 76 indicates when some of the links in a chosen IMA group are not selected, and when some links in the chosen group are not detected in any of the ports. According to an aspect of the present invention, indicators 76a, 76b and 76c are color-coded.

Further, the IMA group select status 76 indicators 76a, 76b and 76c provide a more detailed explanation detailing IMA group select status 76 when selected. Moreover, according to the present invention, when an inverse multiplexed link is selected from grouped inverse multiplexed links, additional information 80 including status information of other links grouped with the selected inverse multiplexed link is displayed.

Accordingly, an IMA network traffic information display method and apparatus for displaying IMA network traffic via a graphical user interface is provided. This enables IMA users to conveniently determine what is happening on the IMA network, and provides access to accurate IMA network traffic information including connection, configuration, and status information of the IMA network in a user-friendly manner. Further, detailed characteristics of errors are also provided to the IMA users, allowing the IMA users to easily pinpoint errors and the cause thereof.

The present invention also provides IMA users with a method and apparatus to verify physical connection and port selections for an IMA group, allows the IMA users to examine the status of each IMA group represented, and provides the IMA users with IMA statistics information. This allows the IMA users to diagnose existing and possible connection and port related problems.

Further, the present invention provides a selectable graphical user interface that indicates missing, misplaced, malfunctioning and misconfigured inverse multiplexed links of the IMA network using a tabular format. This allows IMA users to easily make visual inspection of the status of the inverse multiplexed links and pinpoint problems related to the inverse multiplexed links of the ATM network.

Additionally, the present invention provides a network analyzing apparatus with a graphical user interface displaying statistics information of inter-link delays within each of the grouped inverse multiplexed links, indicating when a link in the grouped inverse multiplexed links is not connected, and indicating when a link in the grouped inverse multiplexed links is incorrectly connected.

The present invention also provides a method for displaying additional information of a selected inverse multiplexed link upon a selection of the link from the grouped inverse multiplexed links where the additional information includes status information of other links grouped with the selected inverse multiplexed link.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A method, comprising:
autodetecting and summarizing traffic information of inverse multiplexed links of an asynchronous transfer mode network in real time, and displaying the summarized traffic information in a tabular form.

2. The method according to claim 1, wherein the traffic information includes corresponding inverse multiplexed group information of the inverse multiplexed links.

3. The method according to claim 1, wherein the traffic information includes link information of each of the inverse multiplexed links.

4. The method according to claim 2, wherein the traffic information includes group delay information of the inverse multiplexed links.

5. The method according to claim 4, wherein the group delay information is determined using an arrival time of cells of one of the inverse multiplexed links as a reference point.

6. The method according to claim 1, wherein the traffic information indicates correctness of connection configuration using a graphical user interface.

7. The method according to claim 6, wherein the graphical user interface includes color-coded buttons and text tips indicating the correctness of connection configuration.

8. A method, comprising:
displaying summarized status information of inverse multiplexed links of an asynchronous transfer mode network using a selectable graphical user interface, wherein the selectable graphical user interface displays selected status information of the inverse multiplexed links.

9. The method according to claim 8, wherein the summarized status information includes at least one of inverse multiplexed link status information, inverse multiplexed group identification information, inverse multiplexed link identification information, and inverse multiplexed group select status information.

10. The method according to claim 9, wherein the summarized status information indicates missing, misplaced, malfunctioning, and misconfigured inverse multiplexed links.

11. The method according to claim 8, wherein the summarized status information is displayed using a tabular format, and includes connection and port selection information of each of the inverse multiplexed links.

12. A network analyzing apparatus, comprising:
a graphical user interface providing summarized traffic data of an asynchronous transfer mode network having grouped inverse multiplexed links connected with corresponding ports, wherein a selectable graphical display displays respective connection and port selection information of each of the grouped inverse multiplexed links.

13. The network analyzing apparatus according to claim 12, wherein the selectable graphical display indicates when an error occurs in relation to the grouped inverse multiplexed links.

14. The network analyzing apparatus according to claim 13, wherein the selectable graphical display indicating the error in relation to the grouped inverse multiplexed links provides text to indicate characteristics of the error.

15. The network analyzing apparatus according to claim 12, wherein the displayed traffic data includes statistics information of inter-link delays within each of the grouped inverse multiplexed links.

16. The network analyzing apparatus according to claim 13, wherein the graphical display indicates when a link in the grouped inverse multiplexed links is not connected and when a link in the grouped inverse multiplexed links is incorrectly connected.

17. The network analyzing apparatus according to claim 16, wherein the selectable graphical display provides a warning indicating a possible error in the traffic data, and indicates when no error is detected from the traffic data.

18. The network analyzing apparatus according to claim 12, further comprising:
displaying additional information of a selected inverse multiplexed link upon a selection of the link from the grouped inverse multiplexed links, wherein the additional information includes status information of other links grouped with the selected inverse multiplexed link.

19. The network analyzing apparatus according to claim 18, wherein the additional information displayed includes potential links of the selected inverse multiplexed link.

20. The network analyzing apparatus according to claim 13, wherein the graphical display indicates when duplicate links are present in a selected group of the grouped inverse multiplexed links.
